(19) United States
(12) Patent Application Publication
(10) Pub. No.: US 2010/0122323 A1
(43) Pub. Date: May 13, 2010

(54) STORAGE DEVICE MANAGEMENT SYSTEMS AND METHODS

(75) Inventors: Chi-Yang Chou, Kao-hsiung (TW); Pei-Yen Chou, Hsin-chu (TW); Yeu-Chung Lin, Chang-hua (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ConDel International Technologies Inc., George Town (KY)

(21) Appl. No.: 12/269,218

(22) Filed: Nov. 12, 2008

(51) Int. Cl. H04L 9/32

(52) U.S. Cl. 726/5

(57) ABSTRACT

Storage device management systems and methods are provided. The system includes a storage device and an electronic device. The storage device has a UID, a public area comprising a URL (Uniform Resource Locator) and a security module, and a hidden area comprising at least one key. The electronic device reads the security module from the storage device, and executes the security module to encrypt the UID. The electronic device links to a host according to the URL, and transmits the encrypted UID of the storage device to the host for management.

### BACKGROUND OF THE INVENTION

1. Field of the Invention

The disclosure relates generally to storage device management systems and methods, and, more particularly to systems and methods that manage a storage device comprising a UID (Unique Identification) and a security module via an electronic device and a remote host.

2. Description of the Related Art

With electronic devices, such as computers or portable devices, being popular, digital data has become a major data recording type for the devices due to increased convenience of digital data. Digital data is always embodied in a data carrier, such as a storage device. The data carrier may vary according to different requirements and applications.

One popular data carrier is a smart card. The smart card is a pocket-sized integrated circuit. The main components of the smart card include a microprocessor and a non-volatile memory, such as an EEPROM. The smart card can receive and process data, and store the processed data in the non-volatile memory of the smart card or output the processed data. The applications for smart cards may be a SIM (Subscriber Identification Module) card for mobile communication, a debit card for banking, a health insurance card, an electronic wallet, and others.

A card reader must be employed to use the smart card. Generally, the card reader must be connected with a computer via a USB (Universal Serial Bus) interface. When the smart card is coupled to the card reader, the card reader supplies power to the smart card, so that the smart card can perform related operations, such as data input, reception and processing of ID authentication, data security management, and others.

Currently, portable devices, such as mobile phones are widely used. In some situations, the smart card is connected with a portable device, such as a mobile phone. In these cases, the portable device must be equipped with the USB interface. However, it is inconvenient for users to simultaneously carry a portable device and a card reader. Further, due to design and manufacturing limitations and cost considerations, the storage capacity of these types of smart cards is limited. The storage capacity of a smart card is within 100 KB. The storage capacity limitation hinders smart card development for related applications.

Therefore, SD (Secure Digital) cards or micro SD cards with high storage capacity, which are widely used by portable devices, are used to emulate the functions of smart cards. In a conventional application, a smart card is packaged into a SD/micro SD card. The microprocessors of the smart card and the SD/micro SD card communicate via the ISO 7816 protocol. For this case, a lot of SDKs (Software Development Kits) must be involved and software of the portable devices must be re-developed to emulate the smart card reader environment. Additionally, since the portable devices may have various OS (Operating System) platforms, software must be developed for each respective OS platform. Thus, making the software development process complicated and time-consuming. Further, the cost for packaging the smart card in the SD/micro SD card is very high.

In another conventional application, the microprocessor design of the SD/micro SD card is directly modified to integrate the functions of the SD/micro SD card and the smart card. Additionally, the non-volatile memory of the smart card is replaced by a flash memory. For this case, since the microprocessor is re-designed, the development cost for the SD/micro SD card is substantially increased. Additionally, since the data output by the SD/micro SD card still subscribes to the ISO 7816 protocol, the software of the portable devices still require re-development to emulate the smart card reader environment.

### BRIEF SUMMARY OF THE INVENTION

Storage device management systems and methods, and related storage devices are provided. In some embodiments, SD/micro SD cards are enabled to function as smart cards.

An embodiment of a storage device management system includes a storage device and an electronic device. The storage device has a UID, and a public area including a URL (Uniform Resource Locator) and a security module. The electronic device reads the security module from the storage device, and executes the security module to encrypt the UID. The electronic device links to a host according to the URL, and transmits the encrypted UID of the storage device to the host for management.

In an embodiment of a storage management method, a storage device is provided. The storage device has a UID and a public area including a URL and a security module. An electronic device reads the security module from the storage device, and executes the security module to encrypt the UID. The electronic device links to a host according to the URL, and transmits the encrypted UID of the storage device to the host for management.

An embodiment of a storage device has a UID and a public area including a URL, and a security module. When the storage device is coupled to an electronic device, the electronic device reads the security module from the storage device, and executes the security module to encrypt the UID. Then, the electronic device links to a host according to the URL, and transmits the encrypted UID of the storage device to the host for management.

In some embodiments, the storage device may further comprises a hidden area comprising at least one key, and the electronic device can further obtain the key from the storage device, and execute the security module to encrypt the UID based on the key.

Storage device management methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a storage device management system according to the invention;

FIG. 2 is a schematic diagram illustrating an embodiment of a storage device according to the invention;

FIG. 3 is a flowchart of an embodiment of a storage device management method according to the invention;

FIG. 4 is a flowchart of another embodiment of a storage device management method according to the invention; and

FIG. 5 is a flowchart of an embodiment of a storage device management method on a host according to the invention.

### DETAILED DESCRIPTION OF THE INVENTION

Storage device management systems and methods, and related storage devices are provided.

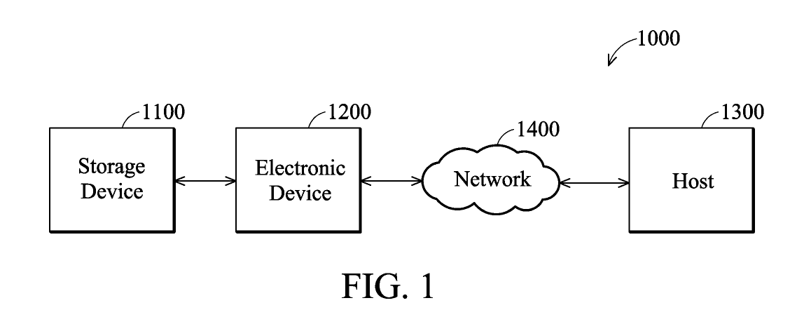

FIG. 1 is a schematic diagram illustrating an embodiment of a storage device management system according to the invention.

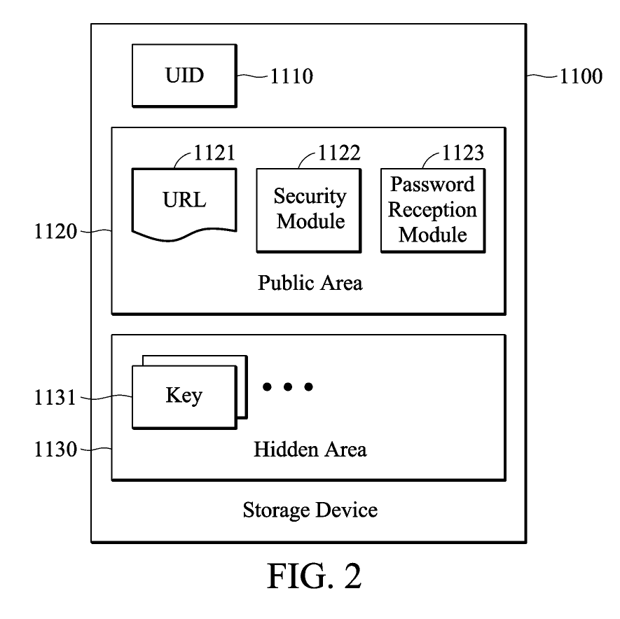

The storage device management system 100 comprises a storage device 1100, an electronic device 1200, and a host 1300. FIG. 2 is a schematic diagram illustrating an embodiment of a storage device according to the invention. The storage device 1100 may be a memory device, such as a SD/micro SD card. The storage device 1100 comprises a UID 1110, a public area 1120, and a hidden area 1130. It is noted that, the storage device 1100 may comprise a semiconductor component, such as a memory, and the UID 1110 is a hardware serial number generated for the semiconductor component during manufacturing or a virtual serial number created for the semiconductor component by firmware/software. The public area 1120 of the storage device 1100 comprises a URL 1121 of the host 1300, a security module 1122, and a password reception module 1123. The URL 1121 can be used to link with the host 1300. The security module 1122 may be software-implemented. The security module 1122 may comprise security functions, such as symmetric or asymmetric encryption/decryption algorithms, PKI, and/or a hash function. When the security module 1122 is executed, a security function is performed. The password reception module 1123 may be also software-implemented. When the password reception module 1123 is executed, an interface is displayed to prompt users to input a password. It is understood that, in some embodiments, the public area 1120 of the storage device 1100 may also comprise applications and/or data (not shown). The hidden area 1130 of the storage device 1100 comprises at least one key 1131 used for the security module 1122. It is noted that, since the key 1131 is in the hidden area 1130, the key 1131 is protected. In some embodiments, the key 1131 in the hidden area 1130 can be only accessed via a data retrieval module in the public area 1120 of the storage device 1100. Similarly, the hidden area 1130 of the storage device 1100 may also comprise data (not shown). The electronic device 1200 may be a processor-based electronic device, such as a computer or a portable device such as a mobile phone. When the storage device 1100 is coupled to the electronic device 1200, the electronic device 1200 can read the UID 1110, and the security module 1122, the password reception module 1123 and/or the data retrieval module from the storage device 1100. The electronic device 1200 then executes the modules, and performs operations provided by the modules. The electronic device 1200 can link to the host 1300 via a network 1400 according to the URL 1120. The network 1400 may be an Internet, and/or a telecommunication network. The host 1300 may be a central management system for storage devices. The host 1300 can receive the encrypted UID 1110, the password input by users, and/or related data from the electronic device 1200, and accordingly perform related management operations. It is understood that, the host 1300 may also comprise security modules to encrypt/decrypt related data. Related details are discussed later.

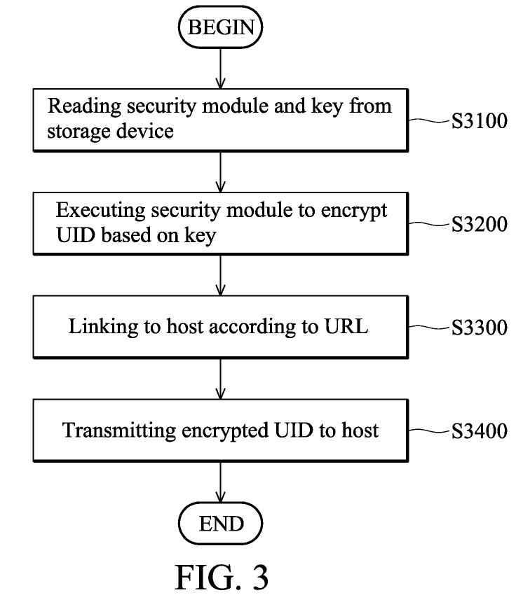

FIG. 3 is a flowchart of an embodiment of a storage device management method according to the invention.

In step S3100, the electronic device 1200 reads the security module 1122 from the public area 1120 of the storage device 1100, and reads the key 1131 from the hidden area 1130 of the storage device 1100. As described, in some embodiments, the electronic device 1200 may first read the data retrieval module from the public area 1120 of the storage device 1100, and execute the data retrieval module, such that the key 1131 in the hidden area 1130 of the storage device 1100 is read via the data retrieval module. In step S3200, the electronic device 1200 executes the security module 1122 to encrypt the UID 1110 based on the key 1131. It is understood that, the electronic device 1200 can first read the UID 1110 of the storage device 1100. Similarly, the UID 1110 may be a hardware serial number generated for a semiconductor component during manufacturing or a virtual serial number created for the semiconductor component by firmware/software. In step S3300, the electronic device 1200 reads the URL 1121 from the public area 1120 of the storage device 1100, and links to the host 1300 via the network 1400 according to the URL 1121. In step S3400, the electronic device 1200 transmits the encrypted UID 1110 of the storage device 1100 to the host 1300 for management. It is noted that, in some embodiments, the electronic device 1200 may further read related data from the public area 1120 of the storage device 1100 or the hidden area 1130 of the storage device 1100 via the data retrieval module, encrypt the data, and transmit the encrypted data to the host 1300 for management.

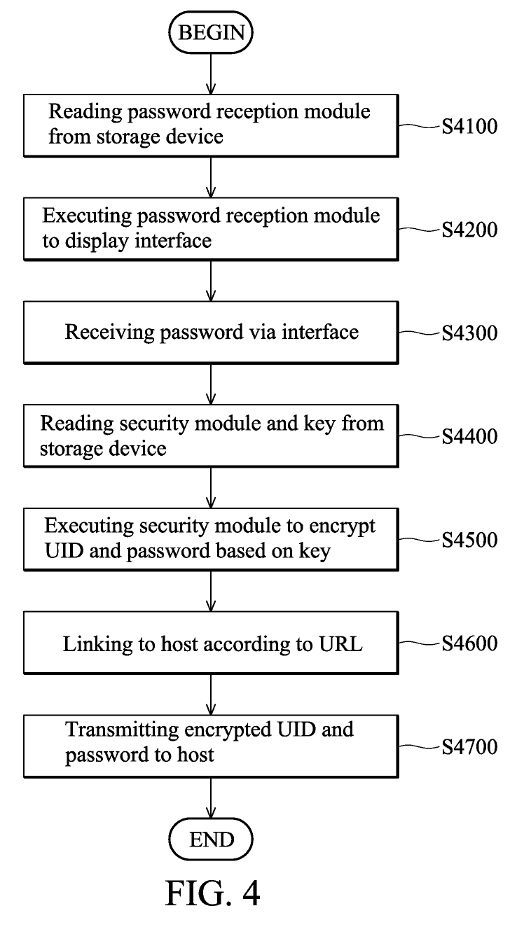

FIG. 4 is a flowchart of another embodiment of a storage device management method according to the invention. In this embodiment, a password is further received for management.

In step S4100, the electronic device 1200 reads the password reception module 1123 from the public area 1120 of the storage device 1100, and in step S4200, executes the password reception module 1123. When the password reception module 1123 is executed, an interface is displayed to prompt users to input a password. In step S4300, a password is received via the interface. In step S4400, the electronic device 1200 reads the security module 1122 from the public area 1120 of the storage device 1100, and reads the key 1131 from the hidden area 1130 of the storage device 1100. Similarly, in some embodiments, the electronic device 1200 may first read the data retrieval module from the public area 1120 of the storage device 1100, and execute the data retrieval module, such that the key 1131 in the hidden area 1130 of the storage device 1100 is read via the data retrieval module. In step S4500, the electronic device 1200 executes the security module 1122 to encrypt the UID 1110 and the password based on the key 1131. Similarly, the electronic device 1200 can first read the UID 1110 of the storage device 1100, and the UID 1110 may be a hardware serial number generated for a semiconductor component during manufacturing or a virtual serial number created for the semiconductor component by firmware/software. In step S4600, the electronic device 1200 reads the URL 1121 from the public area 1120 of the storage device 1100, and links to the host 1300 via the network 1400 according to the URL 1121. In step S4700, the electronic device 1200 transmits the encrypted UID 1110 of the storage device 1100, the encrypted password to the host 1300 for management. Similarly, in some embodiments, the electronic device 1200 may further read related data from the public area 1120 of the storage device 1100 or the hidden area 1130 of the storage device 1100 via the data retrieval module, encrypt the data, and transmit the encrypted data to the host 1300 for management.

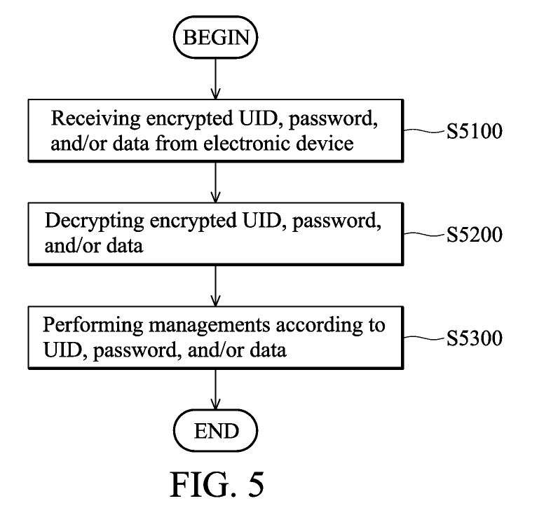

FIG. 5 is a flowchart of an embodiment of a storage device management method on a host according to the invention.

In step S5100, the host 1300 receives the encrypted UID 1110 of the storage device 1100, the encrypted password, and/or the encrypted data from the electronic device 1200 via the network 1400. In step S5200, the host 1300 decrypts the encrypted UID 1110 of the storage device 1100, the encrypted password, and/or the encrypted data using an encryption/decryption algorithm and/or a hash function. It is noted that, the encryption/decryption algorithm and/or the hash function must be matched to the security module 1122. In step S5300, the host 1300 performs management operations for the storage device 1100 according to the UID 1110 of the storage device 1100, the password, and/or the data. It is understood that, in some embodiments, the management operation for the storage device 1100 may be an authentication of the storage device 1100 according to the UID 1110 of the storage device 1100 and/or the password. In some embodiments, the management operation for the storage device 1100 may be a renewal for the key 1131 on the storage device 1100. The host 1300 can determine whether the key 1131 in the storage device 1100 is valid. If the key 1131 in the storage device 1100 is not valid, the host 1300 can determine and update at least one new key to the storage device 1100 by way of the network 1400 and the electronic device 1200. In some embodiments, the management operation for the storage device 1100 may be manipulation of the decrypted data. The host 1300 can further update the manipulated data to the storage device 1200 by way of the network 1400 and the electronic device 1200. As described, the public area 1120 of the storage device 1100 may have at least one application, and the electronic device 1200 may read and execute the application. In some embodiments, the management operation for the storage device 1100 may be a software update for the application on the storage device 1100 by way of the network 1400 and the electronic device 1200. It is understood that, the new key, the manipulated data, and/or the updated application can be further encrypted by the host 1300, and the electronic device 1200 can execute the security module 1122 to decrypt the new key, the manipulated data, and/or the updated application. It is noted that, the management operation for the storage device 1100 may vary according to different requirements and applications, and is not limited thereto.

Therefore, the storage device management systems and methods can manage storage devices comprising a UID and a security module via an electronic device and a remote host. In some embodiments, SD/micro SD cards with high storage capacity which are widely used by portable devices can be enabled to function as smart cards.

Storage device management methods, or certain aspects or portions thereof, may take the form of a program code (i.e., executable instructions) embodied in tangible media, such as flash card or USB disk, wherein, when the program code is loaded into and executed by a machine, such as a computer, the machine thereby becomes an apparatus for practicing the methods.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A storage device management system, comprising:
a storage device having a UID, comprising:
a public area comprising a URL (Uniform Resource Locator), and a security module; and
an electronic device reading the security module from the storage device, and executing the security module to encrypt the UID, linking to a host according to the URL, and transmitting the encrypted UID of the storage device to the host for management.

2. The system of claim 1, wherein the storage device further comprises a hidden area comprising at least one key, and the electronic device further obtains the key from the storage device, and executes the security module to encrypt the UID based on the key.

3. The system of claim 2, wherein the host further performs a renewal for the key on the storage device.

4. The system of claim 2, wherein the public area or the hidden area further comprises data, and the electronic device further executes the security module to encrypt the data and transmits the encrypted data to the host.

5. The system of claim 4, wherein the host further performs manipulation of the encrypted data, and updates the manipulated data to the storage device.

6. The system of claim 1, wherein the public area of the storage device further comprises a password reception module, and the electronic device further reads and executes the password reception module to display an interface, receives a password via the interface, executes the security module to encrypt the password, and transmits the encrypted password to the host.

7. The system of claim 6, wherein the host further decrypts the encrypted UID and the encrypted password, and authenticates the storage device according to the UID and the password.

8. The system of claim 1, wherein the public area of the storage device further comprises an application, and the electronic device further reads the application from the storage device, and executes the application.

9. The system of claim 8, wherein the host further performs a software update for the application.

10. A storage device management method, comprising:
providing a storage device having a UID, wherein the storage device comprises a public area comprising a URL (Uniform Resource Locator), and a security module;
reading the security module from the storage device, and executing the security module to encrypt the UID by an electronic device;
reading the URL, and linking to a host according to the URL; and
transmitting the encrypted UID of the storage device to the host for management by the electronic device.

11. The method of claim 10, wherein the storage device further comprises a hidden area comprising at least one key, and the method further comprises obtaining the key from the storage device, and executing the security module to encrypt the UID based on the key by the electronic device.

12. The method of claim 11, further comprising performing a renewal for the key on the storage device by the host.

13. The method of claim 10, wherein the public area or the hidden area further comprises data, and the method further comprises executing the security module to encrypt the data, and transmitting the encrypted data to the host by the electronic device.

14. The method of claim 13, further comprising performing a manipulation to the encrypted data, and updating the manipulated data to the storage device by the host.

15. The method of claim 10, wherein the public area of the storage device further comprises a password reception module, and the method further comprises the steps of:
reading and executing the password reception module to display an interface by the electronic device;
receiving a password via the interface; and
executing the security module to encrypt the password, and transmitting the encrypted password to the host by the electronic device.

16. The method of claim 15, further comprising decrypting the encrypted UID and the encrypted password, and authenticating the storage device according to the UID and the password by the host.

17. The method of claim 10, wherein the public area of the storage device further comprises an application, and the method further comprises reading the application from the storage device, and executing the application by the electronic device.

18. The method of claim 17, further comprising performing a software update for the application by the host.

19. A storage device, comprising:
a UID; and
a public area comprising a URL (Uniform Resource Locator), and a security module,
wherein when the storage device is coupled to an electronic device, the electronic device reads the security module from the storage device, and executes the security module to encrypt the UID, links to a host according to the URL, and transmits the encrypted UID of the storage device to the host for management.

20. The storage device of claim 19 comprises a SD card or a micro SD card.
